(19) United States
(12) Patent Application Publication
(10) Pub. No.: US 2014/0364230 A1
(43) Pub. Date: Dec. 11, 2014

(54) Apparatus and Method for Rehabilitation Employing a Game Engine

(71) Applicant: Universita' Degli Studi Di Milano, Milano (IT)

(72) Inventors: Nunzio Alberto Borghese, Milano (IT); Pier Luca Lanzi, Milano (IT); Renato Mainetti, Lecco (IT); Michele Pirovano, Bergamo (IT)

(21) Appl. No.: 13/911,577

(22) Filed: Jun. 6, 2013

(51) Int. Cl. A63F 13/537; A63F 13/33; A63F 13/24; A63F 13/285; A63F 13/20; A63F 13/28

(52) U.S. Cl. CPC A63F 13/537; A63F 13/20; A63F 13/28; A63F 13/24; A63F 13/285; A63F 13/33
USPC 463/34; 463/31

(57) ABSTRACT

The invention relates to a method and electronic apparatus for performing computer-aided rehabilitation exercises based on video games. The apparatus comprises a data processing module connected to a memory module to memorise the video games. In addition, the apparatus comprises a display module of the video games connected to the data processing module and at least one electronic input module connected to the data processing module suitable for interacting with a user to generate sequences of digital data representing movements of the user's body during the rehabilitation exercises. The data processing module is configured to compare the sequences of digital input data with reference parameters to provide information to the user during the game representing a biophysical feedback of the rehabilitation exercise performed by the user.

### TECHNOLOGICAL FIELD

The present invention relates to a rehabilitation apparatus and method using a game engine.

### PRIOR ART

With the progressive increase of elderly people in the population of the most developed countries, the number of people who may suffer from dysfunctions such as, for example, those resulting from a stroke, is unfortunately destined to increase in the years to come. As known, an individual who has suffered a stroke in many cases suffers serious disabilities among which the reduction of some motor functions, and in serious cases, even of cognitive functions. Recent studies have shown that intensive rehabilitation paths followed by individuals suffering from such disease permits an improvement and in some cases a substantially full recovery of the damaged functions. However, this requires daily sessions of rehabilitation which currently, can be performed mainly in specialised hospital units, with the support of a therapist. Such traditional rehabilitation paths are unfortunately expensive and consequently only a limited number of individuals suffering from motor disabilities can afford to make use of such services for the long periods required to complete a rehabilitation program.

To overcome such limitations of the traditional rehabilitation methods, recently new rehabilitation methods have been investigated some of which are, in particular, characterised by the use of the latest electronic technology applied to the video games sector.

The large-scale diffusion of electronic devices working as movement sensors or trackers such as Nintendo's Wii Balance Board and Microsoft's Kinect, has revolutionised how video games are played: such trackers capture the player's movements in the real world to transmit them into the game, turning the players themselves into controllers. This way the video-game is much more intuitive than in the past and therefore accessible to a wider public.

Rehabilitation experts have recognised the potential and the advantages offered by the use of such electronic devices combined with video games to guide the rehabilitation exercises in that they are able to reduce the boredom and fatigue which the individuals affected by the aforementioned disabilities typically feel, and at the same time, increase the efficacy of such exercises.

However, the video games commercially available for entertainment purposes cannot be used directly for rehabilitation purposes: such games in fact envisage a pace of interaction of the player with the game which is hard to adapt to individuals with reduced motor capacity, such as patients who are suffering from the after-effects of a stroke. In addition, the wealth of targets and distractors present in commercialised video games may generate anxiety in such individuals.

For such reasons, the need has been felt to develop video games, and more in particular, specifically dedicated methods of playing for rehabilitation purposes. Such known playing methods are the result of the collaboration of video game programmers and therapists and represent integrated solutions for computer-aided rehabilitation conducted mainly in a hospital environment and in the presence of a therapist. In particular in order to have a therapeutic role, it is required that such methods comprise exercises the difficulty of which can be adapted to the current state of the patient.

As regards the aforesaid adaptation requirement, some known methods involve heuristic adaptation methods based on various measurements correlated to patient performance. Other solutions use the game physics to define the adaptation parameters or adapt the game to the patient's psycho-physical state. Yet other known playing methods involve adapting the level of difficulty of the game itself to the expected performance of the patient according to the processing of specific input parameters.

Such methods are described for example, in the documents:
Colombo et al. “Design strategies to improve patient motivation during robot-aided rehabilitation”, Journal of NeuroEngineering and Rehabilitation, Feb. 19, 2007;
Ouriel Barzilay et al., “Adaptive rehabilitation games”, Journal of Electromyography and Kinesiology 23 (2013) 182-189;
Squeri et al., “Adaptive regulation of assistance ‘as needed’ in robot-assisted motor skill learning and neurorehabilitation”, 2011 IEEE International Conference on Rehabilitation Robotics Rehab Week Zurich, ETH Zurich Science City, Switzerland, Jun. 29-Jul. 1, 2011;
Cameirao et al., “The Combined Impact of Virtual Reality Neurorehabilitation and Its Interfaces on Upper Extremity Functional Recovery in Patients With Chronic Stroke”, October 2012.

Such playing methods for computer-aided rehabilitation of the known type suffer from drawbacks and limitations.

In fact, none of the playing methods mentioned above permits an incorrect performance of the rehabilitation exercises by the patient to be detected. In other words, in such methods it is impossible to prevent the patient from adopting the wrong posture during performance of the computer-aided rehabilitation program or from performing incorrect movements making the rehabilitation itself vain or even harmful. Such limitation of the known methodology is particularly relevant in the case in which the patient performs the computer-aided rehabilitation on his/her own, that is to say without the direct guidance of a therapist.

### SUMMARY

The purpose of the present disclosure is to provide and make available a rehabilitation method and apparatus which makes it possible to overcome, at least partially, the drawbacks mentioned above in relation to the aforementioned methods of the prior art.

Such purpose is achieved by an electronic apparatus usable by a user to perform computer-aided rehabilitation exercises based on video games which comprises:

a data processing module;

a memory module operatively connected to the data processing module and configured to memorise the video games;

a display module of the video games operatively connected to the data processing module, said video games including a graphic element of the game and a graphic space of the game wherein said graphic element of the game performs at least one game action;

at least one electronic input module operatively connected to the data processing module, said at least one electronic input module being configured to interact with the user to generate sequences of digital data to be sent to the data processing module representing the movements of the user's body during the rehabilitation exercises, said digital data representing commands suitable for moving the graphic element of the game to perform said at least one game action,

wherein the data processing module is configured to compare said sequences of digital input data with reference parameters to provide information to the user during the game representing a biophysical feedback of the rehabilitation exercise performed by the user, said information being visualised by means of the display module.

The present disclosure also relates to a method for making a user to perform computer-aided rehabilitation exercises based on video games, comprising the steps of:

providing a data processing module operatively connected to a memory module said memory module memorising the video games;

providing a display module of the video games operatively connected to the data processing module, said video games including a graphic element of the game and a graphic space of the game wherein said graphic element of the game performs at least one game action;

generating, by means of at least one electronic input module, sequences of digital data representing the movements of the user's body during the rehabilitation exercises, by means of interaction of the user with the electronic input module, —said electronic input module being operatively connected to the data processing module, said digital data representing commands suitable for moving the graphic element of the game to perform said at least one game action;

sending said digital data to the data processing module;

comparing said digital input data with reference parameters;

providing to the user during the game, by means of the data processing module, information representing a biophysical feedback of the rehabilitation exercise performed by the user;

visualising said information on the display module.

### BRIEF DESCRIPTION OF THE DRAWINGS

Further characteristics and advantages of the method and apparatus according to the invention will, in any case, be evident from the description given below of its preferred embodiments, made by way of a non-limiting example with reference to the appended drawings, wherein:

FIG. 1 shows a block diagram of a hardware system for performing rehabilitation exercises which comprises the rehabilitation apparatus according to the invention;

FIG. 2 shows a functional block diagram of a game architecture for performing rehabilitation memorised in the electronic apparatus in FIG. 1;

FIGS. 3A-3D show, by way of example, the appearance of a user interface of a configuration interface module available to a therapist using a second apparatus of the system in FIG. 1;

FIGS. 4 and 5 show fuzzy membership input function diagrams associated to two reference parameters in input to the apparatus according to the invention;

FIG. 6 shows a fuzzy membership output function diagram, representing an alert level;

FIGS. 7A-7B show examples of an avatar of a user performing the rehabilitation exercises using the system in FIG. 1;

FIG. 8 shows a flow diagram of the method of making a user to perform computer-aided rehabilitation exercises according to the invention.

### DETAILED DESCRIPTION OF PREFERRED EMBODIMENTS

With reference to the aforementioned figures, an example of electronic apparatus will now be described, globally denoted by reference numeral 100, to perform computer-aided rehabilitation exercises and the relative rehabilitation method.

In particular, such rehabilitation exercises are based on video games. In addition, the apparatus 100 is usable by a user 1 which will hereafter indicate a patient affected, for example, by disabilities caused by physical and/or cognitive dysfunctions such as those resulting from a stroke.

It is to be noted that, in the aforementioned figures, the same or similar elements are denoted using the same reference numerals. In addition, the electronic apparatus 100 for performing rehabilitation exercises will hereinafter also be referred to as rehabilitation apparatus, or even, apparatus.

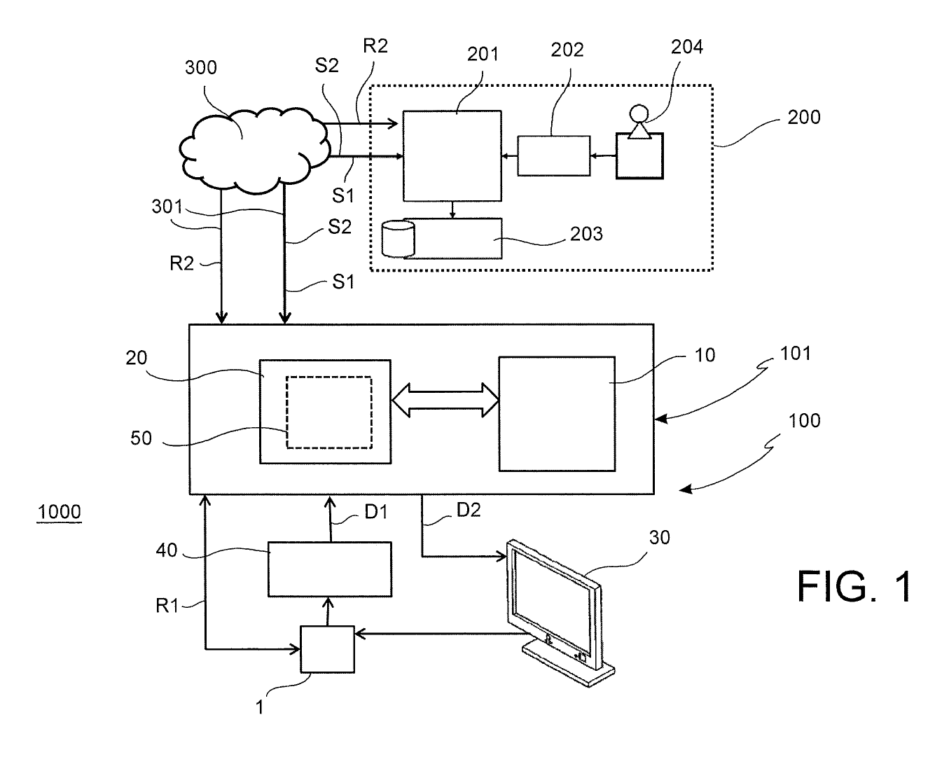

With particular reference to the embodiment in FIG. 1, the rehabilitation apparatus 100 of the invention represents a first apparatus connected to a respective second apparatus 200 to form an integrated rehabilitation system denoted by reference numeral 1000. Preferably, the aforesaid first apparatus 100 is housed at the home of the user 1 and the second apparatus 200, shown inside a first dotted rectangle, is housed in a hospital. Such first and second apparatuses 100 and 200 are connected to each other by an IT network 300 (such as Internet) by means of respective wired communication data lines 301 (using for example the Asymmetric Digital Subscriber Line protocol or ADSL), or wireless data lines (such as 3G, 4G networks).

The rehabilitation apparatus 100 comprises a first processing station 101, including a data processing module 10 or CPU (Central Processing Unit), such as a microprocessor or micro controller, operatively connected to a memory module 20. Such memory module 20 may be internal or external (as shown in FIG. 1) to the data processing module 10. For example, the first processing station 101 takes the form of a desktop computer or notebook having known architectures.

It is to be noted that the memory module 20 is configured to memorise a control software of the video games as will be described in detail below.

In addition, the apparatus 100 comprises a display module 30 of the video games operatively connected to the data processing module 10. In one embodiment, such display module consists of a display 30 external to the first processing station 101, but connected to it, typically a television connected to the first processing station 101 by means of a signal adaptor.

It is to be noted that the video game shown on the display 30 generally includes a graphic element of the game and a graphic space of the game wherein the graphic element of the game performs at least one game action. For example, graphic elements of the game may be the colour and the position of objects or the position of the entire scenario. In the latter case, a scenario may be configured, for example, to move towards/away from the user 1 depending on the movements performed by him/her.

In addition, the apparatus 100 comprises one or more electronic input modules 40 operatively connected to the data processing module 10. Each electronic input module 40 comprises, in particular, one or more movement trackers or sensors. Such sensors are, for example: a board acting as a pressure detector, a haptic interface device, a three-dimensional reconstruction device of body movements (tracking device) of the user 1 represented as a first avatar in movement.

According to a particular embodiment, the board corresponds to the Nintendo Wii Balance Board device, and the tracking device corresponds to the Microsoft Kinect device.

The electronic input module 40 is configured to interact with the user 1 to generate sequences of digital data D1 representing the movements of the user's body during the rehabilitation exercises. According to one embodiment, such digital data D1 represent commands sent to the data processing module 10 to move the graphic game element visualised on the display 30 to perform the game action.

In greater detail, in the case in which the electronic input module 40 is the pressure detector board, such data D1 representing the movement of the body of the user 1 is a sequence of digital data representing the movements of the centre of pressure of the user's body. Such data sequence D1 is thus indicative of variations in pressure exerted by each of the user's legs due to an oscillation of the trunk, or to the raising of a leg, or again to the shift of the body from a seated position to a standing position.

In the case in which the electronic input module 40 is the Kinect tracking device, the aforementioned digital data D1 represent the movement of the entire body of the user 1 or of only a part thereof. In particular the body of the user 1 is schematically represented by means of the first avatar formed of a plurality of segments substantially coinciding with the main segments of the body: foot, lower and upper leg, pelvis, back/chest, arm, forearm and head. the movement of such first avatar is shown on the display module 30 by means of a the translation of a point of reference, called root, coinciding substantially with the pelvis and by means of rotation of the other segments of the body.

In a preferred embodiment, the data processing module 10 is configured to compare such digital input data D1 with appropriate reference parameters to provide to the user 1, in real time during the game, information D2 representing a biophysical feedback (bio-feedback) of the rehabilitation exercise performed by said user.

The aforesaid reference parameters are memorised for example in the memory module 20.

For example, with reference to the use of the Wii Balance Board 40, in the case in which, during the performance of the game, the rehabilitation exercise consists of moving from a seated to a standing position, the biophysical feedback produced by the data processing module 10 is the indication of the presence/absence of significant asymmetries, for the rehabilitation level of the user 1, in the pressure of the right side and of the left side of the body during the performance of such exercise. This can be achieved, by the data processing module 10, by detecting the pressure exerted on the right and left side by means of the aforementioned data D1 provided by the board 40. In other words, the data processing module 10 is configured to compare such data D1 with the reference parameters memorised to assess whether there are significant differences, for the current state of the user 1, between the pressure exerted on the board with one leg compared to the pressure exerted with the other.

It is to be noted that the indication of the presence or not of asymmetries between the right side and the left side of the body during performance of the rehabilitation exercise advantageously supplies the user 1 with an assessment of the correct posture to be maintained during the exercise without requiring the presence of a therapist.

Again with reference to FIG. 1, the second apparatus 200 situated in the hospital comprises a respective processing unit 201 connected to a server device 203 configured for storing data of the user 1 performing the rehabilitation exercises. In particular, such processing unit 201 is provided with a respective configuration interface module 202 accessible to a therapist 204.

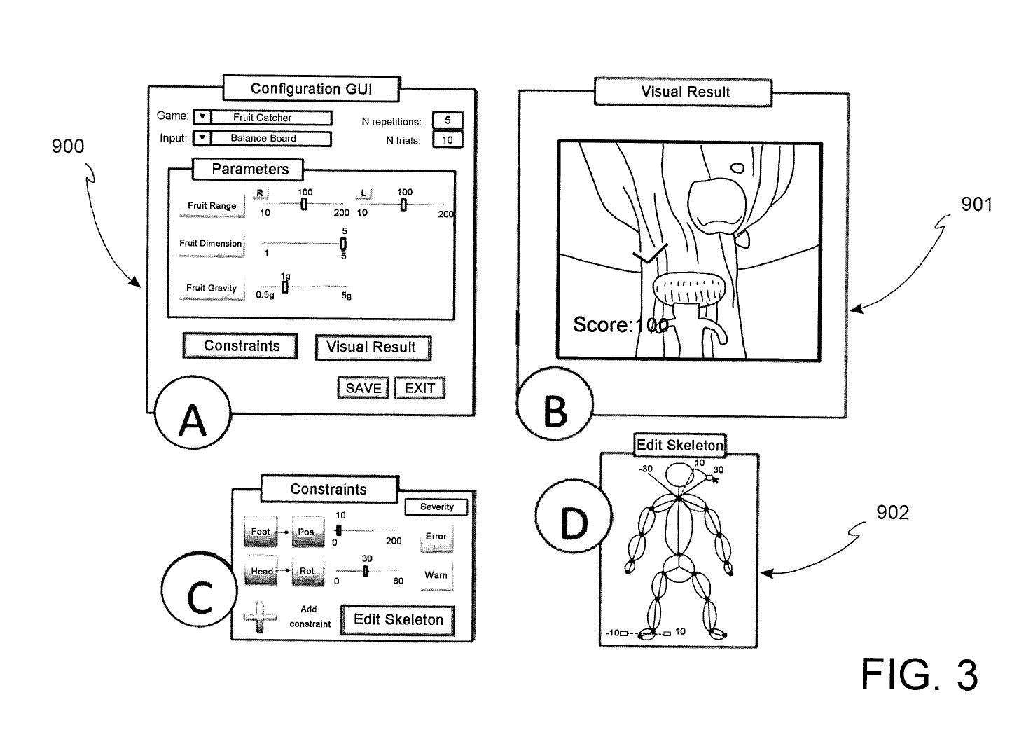

An example of the user interface 900 of the configuration interface module 202 is shown schematically in FIGS. 3A-3C. With reference to the aforementioned figures, the aforementioned reference parameters are entered by the therapist 204 using the interface 202 inside the second apparatus 200, along with the set of exercises constituting the rehabilitation session (for example, the Fruit Catcher game). In particular the therapist 204 is able to set the rehabilitation session or several sessions to be performed during the week on the interface 900, defining for each session, or several sessions the games to be played.

In greater detail, for each game, the therapist 204 is able to enter configuration data of the games S1 in the processing unit 201. Such configuration data S1 determine the level of initial difficulty of the game and define the aforementioned reference parameters (parameters in FIG. 3A). With reference to FIG. 1, such configuration data S1 of the games are suitable for being sent from the second apparatus 200 to the first apparatus 100 via the IT network 300.

According to one embodiment, the interface module 202 further permits the therapist 204 to visualise a preview 901 of the game (VISUAL RESULT function) based on the configuration data S1 set (FIG. 3B) and to obtain a schematic representation 902 of the skeleton of the user 1 (FIG. 3D) and of the movements required during the game depending on the level of difficulty set (EDIT SKELETON function).

This way, the exercises to be performed by the user 1 during the game, and their automatic supervision, can thus be customised for each user.

According to another embodiment, the configuration data S1 of the games also comprise the time allocated for completing the game.

In another embodiment, the therapist 204 is also able to select by means of the configuration interface 202 the electronic input module or modules 40 associated to the exercise which the user 1 is interacting with (such as the Wii Balance Board in FIG. 3A).

As regards the effects of rehabilitation, monitoring performed all over the skeleton of the user 1 is more reliable. In fact, in this case it is possible to monitor if the patient keeps the trunk straight, that there is no lateral or frontal bending and that the legs are kept straight.

In one embodiment, using the Kinect tracker this is obtained for example by measuring the angles formed between the segments associated with the parts of the body of the user 1 represented as the first avatar by such tracker device. In particular the orientation of each segment is compared with the reference value of the parameter set by the therapist 204 by means of the configuration interface 202 to control the posture maintained by the user during rehabilitation.

In a further embodiment, to improve the effects of monitoring of the user 1, the combined use of the Wii balance board and the Kinect tracker is provided for.

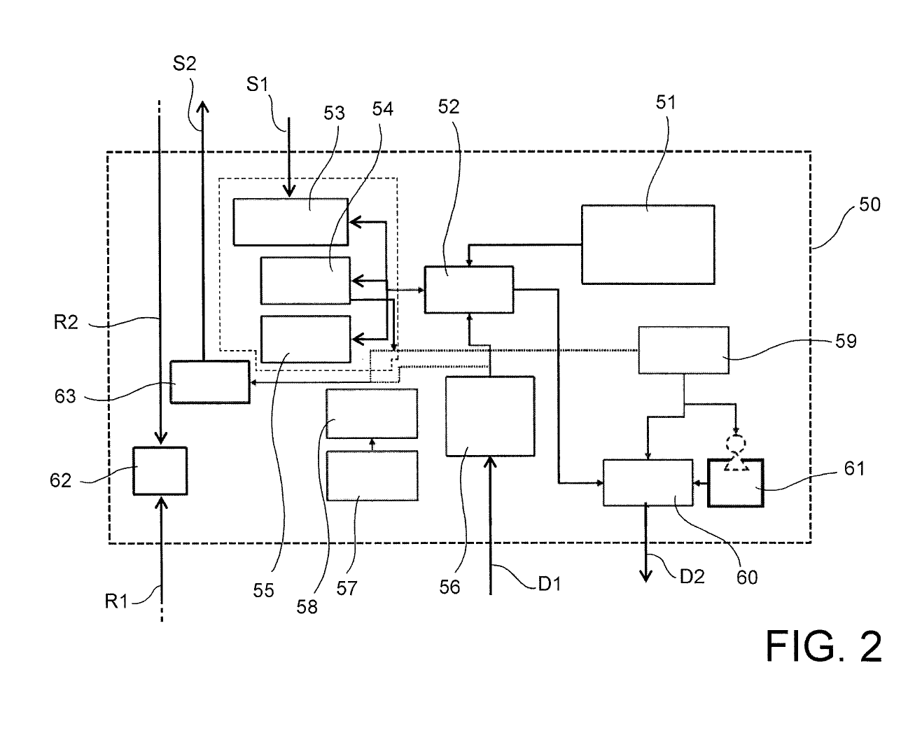

With reference to the first apparatus 100 situated in the home of the user 1, the software or game architecture configured for the performance of the rehabilitation exercises by means of games is schematically represented by means of a second dotted rectangle 50. Such game architecture 50 has a modular structure which may be described in greater detail with reference to the functional blocks diagram in FIG. 2. Each of the aforesaid blocks represents a function implemented by the software of the invention.

The aforesaid game architecture 50 comprises in particular a game engine functional block 51 representing the current software which runs the games for the user 1. Game engines of the known type provide for cyclically running a series of procedures for an indefinite period, usually at a fixed frame rate in relation to the update frequency of a screen. Such game engines consequently, after initialising the game, proceeds on the basis of the following steps, cyclically repeated:

collecting inputs of player;

processing the game rules on the basis of a current state and of new input data, such as the input data D1;

updating the game status, such as the position of objects and game agents so as to satisfy both geometric constraints (collision management) and physical constraints (physical properties of materials);

showing the game scenario as modified, to the player using the screen.

Given that such game engine 51 is of the conventional type, it will not be described in further detail below.

In one embodiment, the scenarios created for rehabilitation video games according to the invention may be related among them by a common theme, so as to be able to develop different episodes of the same theme. In this case, the conclusion of one game will be configured to introduce the next game so as to maximise the motivation of the patient to perform a complete rehabilitation session.

In addition, reward mechanisms typical of video games may be used to reward users successfully completing one game level and to provide them with virtual elements to insert in the scenario to enrich it.

In a particular embodiment, the results and the rewards collected may be shown to other users and friends in a virtual community which also permits an exchange of impressions and information.

The game engine block 51 is configured to control a games block 52. The latter may, in particular, be configured on the basis of information exchanged between such games block 52 and a configuration block 53, an adaptation block 54 and a variability block 55.

It is to be noted that all the aforesaid blocks 53, 54, 55 are programmable, that is to say may be modified during implementation of the game.

In greater detail, the configuration block 53 is configured to receive, for each new rehabilitation session, the configuration data S1 from the second apparatus 200 of the hospital concerning the exercises to be performed during the game. Such configuration data S1 and the relative reference parameters are memorised in the memory module 20 of the first apparatus 100.

With reference to the adaptation block 54 of the game, as recalled above, the therapist 204 is able to select the difficulty of the game by setting some of the typical parameters of the game through the second apparatus 200, such as for example the frequency and/or interval with which particular target objects of the game fall. During performance of the game, such parameters may be further modified to adapt them to the psycho-physical state of the user 1, increasing/decreasing the difficulty of the game so that the user tends to achieve pre-set successful performances (for example equal to 80%). Such adaptation is implemented by the block 54 using a Bayesian framework of the known type which takes into account both the reference parameters set by the therapist 204 with the configuration data S1 in the configuration block 53 and the desired percentage of success rate to be achieved.

In one particular embodiment, at least one object in the scene and/or the entire game scene are configured to move with a given motion equation and along a known trajectory to generate dynamic stimuli with which the user 1 has to interact. Such dynamic stimuli may be adapted, for example in frequency or intensity, on the basis of measurements taken from the input data D1 acquired by the tracker devices.

The variability block 55 is configured to increase the variability of the stimuli starting from the representation of the game scenes and assets.

The game architecture 50 further comprises an abstraction block of the input data 56 which represents an interface between the functional game block 52 and the electronic input module 40 to receive the input data D1 representing the movement of the user 1 during the games. By means of such abstraction block 56, the game architecture 50 permits the adaptation of the game to different electronic input modules 40.

In addition, the game architecture 50 comprises a menu function block 57 and a respective interface function block 58 configured to guide the rehabilitation session by providing a selectable menu of the games.

According to a preferred embodiment, the game architecture 50 comprises a monitoring function block configured to monitor the performance of the exercises by the user 1.

On the basis of detection of the method of performing the exercise (correct/incorrect), the game architecture 50 is configured to interact with the user 1 by means of a feedback block 60 controlled by the monitoring block 59. In particular such feedback block 60 is configured to generate and send substantially in real time and automatically the aforementioned biofeedback information to the user 1, that is to say the feedback information D2 via the output display module 30.

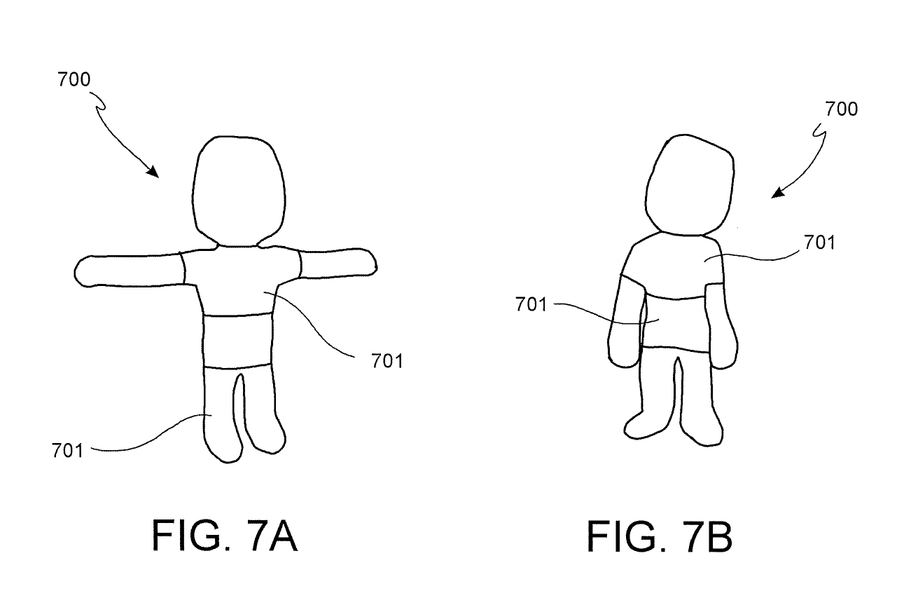

In addition, the monitoring block 59 is configured to control a virtual therapist function block 61 configured for acting on the feedback block 60. According to one embodiment, the virtual therapist block 61 is configured to generate a first feedback to the user 1. Such first feedback comprises the visualisation via the output display module 30 of a second avatar 700 of the body of the user 1 comprising respective portions 701 of the body which change colour in real time. Examples of such second avatar 700 are shown in FIGS. 7A and 7b. In particular the portions 701 of the body of the second avatar 700 which change colour represent those parts of the body of the user 1 which perform the exercises incorrectly. In particular by means of such second avatar 700, different levels of seriousness of the error are shown by means of the aforementioned variations in colour of the portions 701 in a range from green (indicating no error) to red (indicating a serious error).

Following the maximum pre-set error being reached, in a particular embodiment, the virtual therapist block 61 is configured to generate a second feedback to the user 1 in addition to the aforesaid first feedback. Such second feedback comprises a guide voice which cuts in to explain the correct movement to be performed to the user 1.

In an alternative embodiment a third feedback to the user 1 comprises an animated picture of a virtual therapist visualised by means of the display module 30 to inform the user of how to correctly perform the exercise.

In a particular embodiment, such third feedback provided to the user 1 is regulated by means of a timer to prevent the frequent appearance of the virtual therapist from being overly intrusive and distracting the patient during the performance of the exercise.

In one embodiment, the game architecture 50 comprises a data collection block 63 configured to memorise game data S2 representing the results of the functions of real time monitoring and adaptation, obtained from the interaction of the user 1 with the game. Such game data S2 are sent to the second apparatus 200, together with the adaptation data, and to the input tracking data D1, to permit the therapist 204 to assess the progress of rehabilitation.

In one embodiment, on the basis of the aforesaid game data S2, if the processing module 201 of the second apparatus 200 finds a consistent and persistent error level during an exercise, this is translated into an alert to the therapist 204. In such case, a video-conference is set up between the user 1 and the therapist 204 while, as recalled above, the presence of the therapist during the rehabilitation sessions is not required, even virtually.

To such purpose, the game architecture 50 also comprises a video call block 62, able to manage video call request signals R1, R2 from the patient 1 or from the second apparatus 200 in the hospital to permit a direct communication between the patient 1 and the therapist 204 in the hospital.

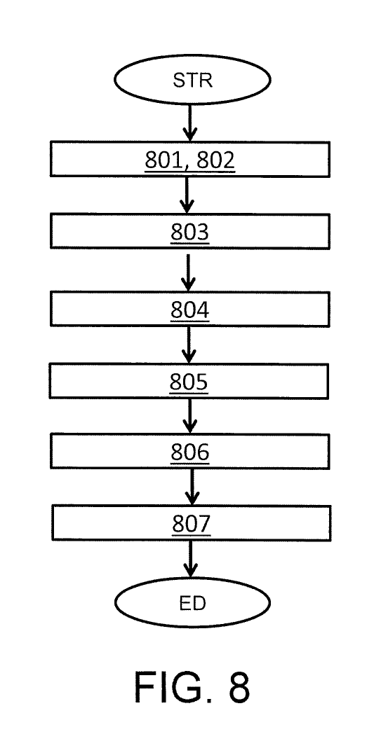

From the aforementioned structural and functional characteristics of the electronic apparatus 100, with reference to FIG. 8, a method 800 to make a user 1 perform rehabilitation exercises is now described. In particular such rehabilitation exercises are computer-aided and based on video games.

Reference will be made henceforth to the rehabilitation system 1000 described above in as general a manner as possible and also according to the possible embodiments.

The method for making the user to perform rehabilitation exercises by means of video games, hereinafter simply method 800, comprises a symbolic start step STR.

Subsequently, the method 800 comprises a first step of providing 801 the data processing module 10 operatively connected to the memory module 20. In particular such memory module 20 stores the video games and the reference parameters.

The method also comprises a second step of providing 802 the display module 30 of the video games operatively connected to the data processing module 10. As recalled above, the video games include a graphic element of the game and a graphic space of the game wherein the graphic element of the game performs at least one game action.

Subsequently, the method comprises a generating step 803 of sequences of digital data D1 representing the movements of the body of the user 1 during the rehabilitation exercises.

This takes place by using one or more of the electronic input modules 40 which interact with the user 1. Each electronic input module 40 is operatively connected to the data processing module 10. In addition, the digital data D1 represent commands suitable for moving the graphic element of the game to perform at least one game action.

In addition, the method comprises a step of sending 804 the digital data D1 generated to the data processing module 10.

Subsequently, the method comprises a monitoring or comparison step 805 of the digital input data D1 with the reference parameters defined by the therapist 204 by means of the configuration interface 202 of the second apparatus 200.

In addition, the method comprises a step 806, wherein the data processing module 10 provides to the user 1, during the game, information representing a biophysical feedback of the rehabilitation exercise performed by the user 1.

In addition, the method comprises a visualisation step 807 of the information representing a biophysical feedback on the display module 30.

According to a first embodiment (not shown in FIG. 8), such step 807 comprises the further step of supplying the result of monitoring directly to the user 1 by means of the display module 30.

According to a second embodiment (not shown in FIG. 8), such step 807 comprises a step of further processing the result of monitoring of the exercises by the data processing module 10, for example if several types of monitoring are active.

In such case, a step of providing the user 1 with the monitoring result associated with the most serious error is provided for. The final result of such further processing is subsequently visualised by means of the display module 30.

The method ends with a symbolic end step ED.

According to a preferred embodiment, the aforementioned monitoring step 805 comprises a step of monitoring based on fuzzy logic.

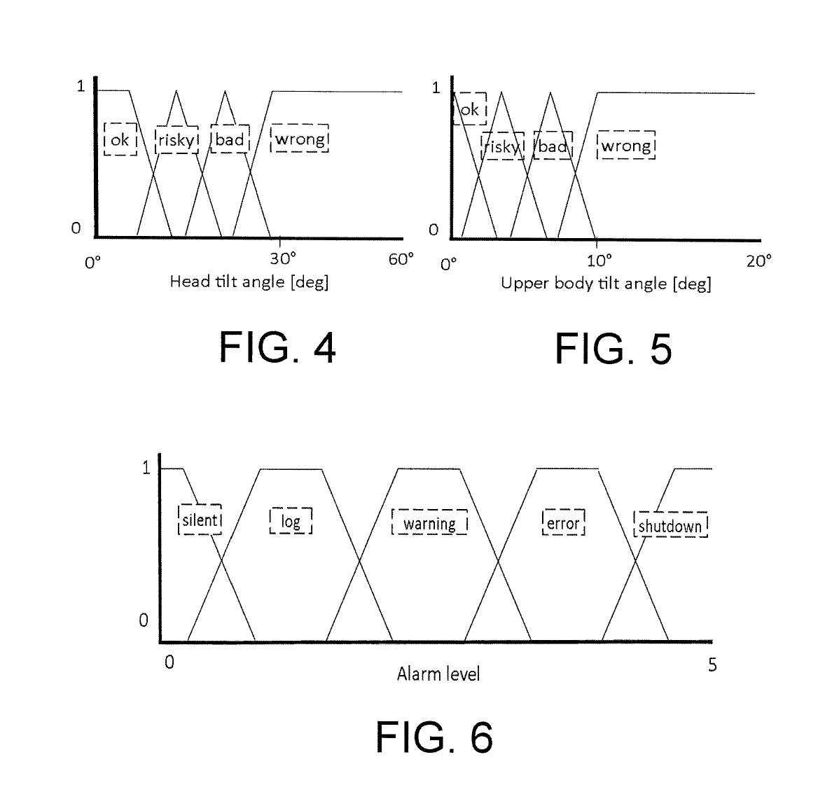

By way of example, diagrams of fuzzy type membership functions associated to two input reference parameters are shown in FIGS. 4 and 5. In particular, FIG. 4 shows the diagram of the fuzzy function associated to the input parameter “Head tilt angle” measured in degrees. FIG. 5 shows the diagram of the fuzzy function associated to the input parameter “Upper body tilt angle” measured in degrees.

FIG. 6 shows a fuzzy membership output function diagram, representing an alert level.

With reference to the aforesaid FIGS. 4 and 5, for each game rule, the input parameters on which such rule depends are associated to a set of fuzzy membership classes: “Ok”, “risky”, “bad”, “wrong”. This way, the method defines a progressive level of correctness of the model of effective movement of the user 1.

The shape of the membership function to which each class of movement belongs may be defined in a semi-automatic manner at the processing module 201 of the second apparatus 200 in hospital.

In a preferred embodiment, the therapist 204 is able to define the boundaries for the fuzzy classes of movement “OK” and “wrong” of the reference parameters on the basis of the graphic representation of the skeleton 902 of the user 1, shown, for example in FIG. 3D.

In one embodiment, the method provides for the step of defining the trapezoidal fuzzy membership functions and their boundaries are generated automatically by dividing the range appropriate for attributing the adequate amplitude to each class, without the need for further intervention by the therapist 204. This way, relative movements of the body of the user 1 beyond the absolute movements may be represented. This way, the therapist 204 is able to define, for example, that the relative movement of one foot in relation to the other is within pre-defined boundaries.

It is to be noted that using the fuzzy logic, the reference parameters may be combined with each other using the logic operators, AND, OR and NOT.

In addition, the monitoring method based on fuzzy logic accepts, for example, variables which explicitly take into account time, previous alerts, and performance indexes of the user 1.

The monitoring rules are associated to the exercised prescribed by the therapist 204 by means of the configuration interface 202 and are sent to the first apparatus 100. Such rules are mapped to the same single fuzzy output function, that is, alert level, by means of a fuzzy associative memory. Such output function comprises five associated fuzzy sets: “silent”, “logging”, “warning”, “error”, “shutdown”.

In a preferred embodiment, the method 800 comprises a step of mapping the input type functions to the corresponding fuzzy output function depending on the seriousness of the corresponding rule. This way, some movements of the user during an exercise weigh more on the final alert. For example, a given variation from the reference parameters may trigger an “error” alert for a rule. The same variation may trigger a “warning” alert for another rule.

In one embodiment, such method provides for a step of defuzzyfication based on the mean (mean of maximum) of the values of the input variables and a T-norm algebra of the type known to a person skilled in the art to assess the rules and output classes which need to be activated and their degree of activation.

Based on the result of such defuzzyfication step, the different classes trigger a different behaviour of the apparatus 100.

For example, with reference to FIG. 6, when the alert level is zero, no action is performed. The alert level is thus fixed at the “silent” level.

When the alert reaches the “logging” level, a report on the cause of the alert and a stamp are added to the game. This may be useful for subsequent analysis by the therapist 204.

If the “warning” level is reached, the method provides for the issue of a warning to the patient, to urge him/her to correct the improper movement. The event is recorded by the module 63.

When the level reaches a “wrong” movement the “error” level of seriousness may be reached. As well as emitting a warning and recording the event, the video game is set to pause. The user 1 receives an explanation on the cause of the error via the virtual therapist block 61 and the game may be resumed or repeated.

The “shutdown” level is restricted to dangerous situations in which the movements of the user 1 are too different from the correct movements. In this case, the video game is stopped and a warning is immediately sent to the second apparatus 200 in hospital via the module 63 to urge the therapist 204 to get into contact with the user 1.

The method 800 and the apparatus 100 for performing rehabilitation exercises using video games according to the invention have numerous advantages compared to the known methods.

In particular, the apparatus 100 for performing the exercises provides, via the game engine 51, all the functions for the video game.

In addition, given its therapeutic role, the method 800 is configured to adapt the difficulty of the game, substantially in real time to the current state of the user 1.

The game architecture 50 implemented is configured to monitor the performance of the game, reporting any improper performance of the exercises by the user 1.

In addition, the method 800 according to the invention provides a real time response or biophysical feedback to the user 1 during performance of the exercises and permits acquisition of all the movement data S2 to be transmitted to the remote apparatus 200 to permit the therapist 204 to assess the results of rehabilitation.

In addition, with the apparatus 100 which implements the method according to the invention, it is possible to make the user 1 to perform rehabilitation directly at home, avoiding lengthy and expensive stays in specialised facilities.

A person skilled in the art may make modifications and variations to the embodiments of the method and apparatus described above, replacing elements with others functionally equivalent so as to satisfy contingent requirements while remaining within the sphere of protection of the following claims. Each of the features described as belonging to a possible embodiment may be realised independently of the other embodiments described.

1. An electronic apparatus utilisable by a user to perform computer-aided rehabilitation exercises based on video games, comprising:
a data processing module;
a memory module operatively connected to the data processing module and configured to memorise the video games;
a display module of the video games operatively connected to the data processing module, said video games including a graphic element of the game and a graphic space of the game wherein said graphic element of the game performs at least one game action; and
at least one electronic input module operatively connected to the data processing module, said at least one electronic input module being configured to interact with the user to generate sequences of digital data to be sent to the data processing module representing the movements of the user's body during the rehabilitation exercises, said digital data representing commands suitable for moving the graphic element of the game to perform said at least one game action,
wherein the data processing module is configured to compare said sequences of digital input data with reference parameters to provide information to the user during the game representing a biophysical feedback of the rehabilitation exercise performed by the user, said information being visualised by means of the display module.

2. The electronic apparatus according to claim 1, wherein said at least one electronic input module comprises a movement sensor or tracker.

3. The electronic apparatus according to claim 2, wherein said sensor is chosen, for example but not limited to, a group consisting of: a board acting as a pressure detector; a haptic interface device; a three-dimensional reconstruction device of the user's body movements.

4. The electronic apparatus according to claim 3, wherein if the electronic input module is the pressure detector board, the data representing the movement of the user's body comprises a sequence of digital data representing the movement of the centre of pressure of the user's body.

5. The electronic apparatus according to claim 3, wherein if the electronic input module is the tracking device, said digital data represent the movement of the entire body of the user or of only a part thereof.

6. The electronic apparatus according to claim 1, further comprising a game architecture having a functional module structure memorised in the memory module, said game architecture comprising a game engine functional block.

7. The electronic apparatus according to claim 6, wherein said game architecture comprises a games block controlled by the game engine functional block, and configurable on the basis of information exchanged with a configuration block, an adaptation block and a variability block.

8. The electronic apparatus according to claim 7, wherein said configuration block, adaptation block and variability block can be modified when the game is running.

9. The electronic apparatus according to claim 7, wherein said configuration block is configured to receive, for each new rehabilitation session, configuration data relative to the exercises to be performed during the game.

10. The electronic apparatus according to claim 9, wherein said adaptation block is configured to adapt such configuration data, during the game, to adapt them to the psycho-physical state of the user by means of a Bayesian framework.

11. The electronic apparatus according to claim 6, wherein said game architecture comprises an abstraction block of the input data representing an interface between the games block and the electronic input module, said abstraction block permitting the adaptation of each video game to different electronic input modules.

12. The electronic apparatus according to claim 6, wherein said game architecture comprises a monitoring function block suitable for monitoring the correct implementation of the exercises by the user.

13. The electronic apparatus according to claim 12, wherein said game architecture further comprises a feedback function block controlled by the monitoring block to generate and send in real time said biofeedback information to the user.

14. The electronic apparatus according to claim 13, wherein said game architecture further comprises a virtual therapist function block controlled by the monitoring block to generate a first feedback to the user, said first feedback comprising an avatar of the user's body having portions of the body which change colour in real time, representing parts of the user' body performing an exercise incorrectly.

15. The electronic apparatus according to claim 14, wherein said colour is variable in a range from green, indicating no error, to red, indicating a serious error.

16. The electronic apparatus according to claim 14, wherein the virtual therapist block is configured to generate a second feedback to the user comprising a guide voice upon a maximum pre-set error being reached.

17. The electronic apparatus according to claim 14, wherein the virtual therapist block is configured to generate a third feedback to the user comprising an animated picture of a virtual therapist visualised by means of the display module upon a maximum pre-set error being reached.

18. The electronic apparatus according to claim 17, wherein said third feedback is regulated by means of a timer.

19. A method for making a user to perform computer-aided rehabilitation exercises based on video games by means of a first electronic apparatus comprising the steps of:
providing a data processing module operatively connected to a memory module said memory module memorising the video games;
providing a display module of the video games operatively connected to the data processing module, said video games including a graphic element of the game and a graphic space of the game wherein said graphic element of the game performs at least one game action;
generating, by means of at least one electronic input module, sequences of digital data representing the movements of the user's body during the rehabilitation exercises by means of interaction of the user with the electronic entry module, said electronic input module being operatively connected to the data processing module, said digital data representing commands suitable for moving the graphic element of the game to perform said at least one game action;
sending said digital data to the data processing module;
comparing said digital input data with reference parameters;
providing to the user during the game, by the data processing module, information representing a biophysical feedback of the rehabilitation exercise performed by the user; and
visualising said information on the display module.

20. The method according to claim 19, wherein such visualisation step comprises the step of supplying the result of monitoring directly to the user by means of the display module.

21. The method according to claim 19, wherein said visualisation step comprises the further steps of:
further processing, by the data processing module, of the results of a plurality of active monitoring processes; and
providing the user with the monitoring result associated with the most serious error during performance of the exercise.

22. The method according to claim 19, wherein said step of providing information representing a biophysical feedback comprises a monitoring step based on fuzzy logic, comprising the steps of:
determining at least one fuzzy rule;
associating two or more of the input reference parameters to fuzzy-type membership functions;
associating to a set of fuzzy type membership classes said input parameters on which such at least one rule depends;
mapping the input type membership functions to an output type membership function representing an alert level depending on the seriousness of said at least one rule; and
defuzzyfying the output function based on a mean (mean of maximum) of the values of the input variables and a T-norm algebra.

23. The method according to claim 22, wherein said reference parameters associated with fuzzy type membership functions may be combined with each other using the logic operators, AND, OR and NOT

24. The method according to claim 19, wherein said step of comparing said digital input data with the reference parameters comprises the step of:
entering, by a therapist, said reference parameters into a second electronic apparatus connected to said first apparatus by means of an interface configuration module; and
sending said reference parameters from the second electronic apparatus connected to the first electronic apparatus, via an IT network.

25. The method according to claim 24, wherein said step of entering the reference parameters by means of the interface configuration module comprises the further steps of:
visualising a preview of the game based on the reference parameters set; and
obtaining a schematic representation of the skeleton of the user and of movements required during the video game.

26. The method according to claim 19, wherein said reference parameters comprise information on the time allocated for completion of the game.

27. The method according to claim 24, further comprising the step of selecting, via the interface configuration module, by the therapist of the electronic input module or modules associated with the exercise which the user interacts with.

28. A system for making a user to perform computer-aided rehabilitation exercises based on video games, comprising:
a first rehabilitation apparatus according to claim 1; and
a second apparatus connected to said first apparatus by means of an IT network.

29. The system according to claim 28, wherein said second apparatus is housed in a hospital and said first apparatus is housed in the user's home.
